(19) United States
(12) Patent Application Publication
(10) Pub. No.: US 2012/0051806 A1
(43) Pub. Date: Mar. 1, 2012

(54) IMAGE HEATING APPARATUS

(75) Inventor: Masahiro Takahashi, Kashiwa-shi (JP)

(73) Assignee: CANON KABUSHIKI KAISHA, Tokyo (JP)

(21) Appl. No.: 13/221,002

(22) Filed: Aug. 30, 2011

(30) Foreign Application Priority Data
Aug. 31, 2010 (JP) 2010-193704

(51) Int. Cl. G03G 15/20

(52) U.S. Cl. 399/323

(57) ABSTRACT

An image heating apparatus includes a rotatable image heating member; a pressing member for forming a nip for heating a the image formed on a recording material; a external heating member for heating externally the image heating member; a duct surrounding the external heating member; and an air separating device for separating the recording material having passed through the nip from the heating member by blowing air supplied from the duct toward the image heating member from a downstream side of the nip with respect to a feeding direction of the recording material.

### FIELD OF THE INVENTION AND RELATED ART

The present invention relates to an image heating apparatus which is preferable as a fixing device to be mounted in an image forming apparatus, such as a copying machine, a facsimile machine, a printer, etc., which outputs a hard copy by forming an image on recording medium with the use of an electrophotographic image forming method, or the like.

The ordinary usage of an image heating apparatus is to thermally fix an unfixed image formed on recording medium, to the recording medium. However, there are other usages for an image heating apparatus. For example, an image heating apparatus can be used as an apparatus for heating a fixed image on recording medium to increase the fixed image in gloss.

In a case where an electrophotographic image forming apparatus is used to print an image on recording medium (which hereafter may be referred to simply as paper), a toner image (unfixed image) is transferred from the photosensitive drum, or transfer medium, such as an intermediary transfer belt, of an image forming apparatus, onto a sheet of paper. Then, the sheet of paper is conveyed to the fixation station of the image forming apparatus, in which the toner image is permanently fixed to the sheet. Then, the sheet is conveyed toward the outlet of the image forming apparatus. The fixation station has a pair of fixation rollers. One of the fixation rollers is a heat roller, and the other is a pressure roller. The pressure roller is positioned in parallel to the heat roller and is kept pressed upon the heat roller. Incidentally, some fixing apparatuses have a combination of a heat belt and a pressure belt instead of the combination of a heat roller and a pressure roller. In this specification, the present invention is described with reference to a fixing device having the combination of a heat roller and a pressure roller.

After the transfer of a toner image onto a sheet of paper, the sheet is entered into the nip between the pair of fixation rollers, and then, is conveyed through the nip. As the sheet is conveyed through the nip, not only is the toner image heated by the heat from the heat roller, but also, it is compressed by the combination of the heat roller and pressure roller. As a result, the toner image becomes permanently fixed to the sheet of paper. One of the technical issues regarding the fixation station is how to prevent the problem that as a sheet of paper comes out of the fixation nip, it wraps around the heat roller.

One of the means for solving the above-mentioned technical problem is proposed in the invention disclosed in Japanese Laid-open Patent Application H05-71865. According to this application, as a sheet of paper comes out of the fixation nip, compressed air is blown into the interface between the sheet and heat roller so that the sheet is separated from the heat roller by the air pressure. Also according to this application, not only can this method separate a sheet of paper from the heat roller without damaging the peripheral surface of the heat roller, but also, it is unlikely to scar or seriously damage the sheet and the toner image thereon. Therefore, this method enables an image forming apparatus to output a print which is excellent in image quality.

This method, however, is problematic for the following reason. That is, as compressed air is blown at the peripheral surface of the heat roller of a thermal fixing apparatus, the peripheral surface of the heat roller is robbed of its heat. Thus, the fixing apparatus is reduced in its ability to thermally fix the unfixed tone image. That is, blowing compressed air into the nip between a sheet of paper and the heat roller of a fixing apparatus is likely to cause the fixing apparatus to output a copy with an under-fixed toner image, a copy which is nonuniform in gloss, and/or the like low quality images.

Thus, inventions which deal with the above-described problem have been made. One of such invention is disclosed in Japanese Laid-open Patent Application 2007-94327. According to this invention, the compressed air which is to be blown at a heat roller is preheated to prevent the peripheral surface of the heat roller from reducing in temperature. Since the compressed air to be blown at a heat roller is preheated, the fixing apparatus is unlikely to output a print with an insufficiently fixed toner image and/or a print which is nonuniform in gloss.

However, the invention disclosed in Japanese Laid-open Patent Application 2007-94327 is problematic for the hollowing reason. That is, it places a heating means in the passage for compressed air. Therefore, it generates an air turbulence in the air passage, and the air turbulence reduces the efficiency with which the compressed air is blown at the heat roller. Moreover, the invention provides the image heating apparatus with a means dedicated to the heating of the compressed air. Therefore, it increases an image heating apparatus in electric power consumption, and also, in size.

### SUMMARY OF THE INVENTION

Thus, the primary object of the present invention is to provide an image heating apparatus which employs an air flow directing device and is smaller in size and electrical power consumption than any conventional image heating apparatus which employs an air flow directing device.

According to an aspect of the present invention, there is provided an image heating apparatus comprising a rotatable image heating member; a pressing member for forming a nip for heating a the image formed on a recording material; a external heating member for heating externally said image heating member; a duct surrounding said external heating member; and an air separating device for separating the recording material having passed through said nip from said heating member by blowing air supplied from said duct toward said image heating member from a downstream side of said nip with respect to a feeding direction of the recording material.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a vertical sectional view of the image heating apparatus (fixing apparatus) in one of the preferred embodiments of the present invention, at a plane perpendicular to the axial line of the heat roller of the apparatus, as seen from the right-hand side of the apparatus.

FIG. 2 is a partially broken perspective view of the image heating apparatus (fixing apparatus) shown in FIG. 1, as seen from the recording medium entrance side (front side) of the apparatus.

FIG. 3 is a partially exploded view of the left end portion of the image heating apparatus shown in FIG. 2.

FIG. 4 is a partially broken perspective view of the apparatus shown in FIG. 2, as seen from the recording medium exit side (rear side) of the apparatus.

FIG. 5 is a schematic sectional view of an example of image forming apparatus to which an image heating apparatus (fixing apparatus) in accordance with the present invention is compatible. It shows the general structure of the apparatus.

### DESCRIPTION OF THE PREFERRED EMBODIMENTS

Hereinafter, the present invention is concretely described with reference to one of the preferred embodiments of the present invention. Incidentally, although the following embodiment to which the description of the present invention is referred is one of the preferred embodiments of the present invention, it is not intended to limit the present invention is scope.

### Embodiment

### <Image Formation Station>

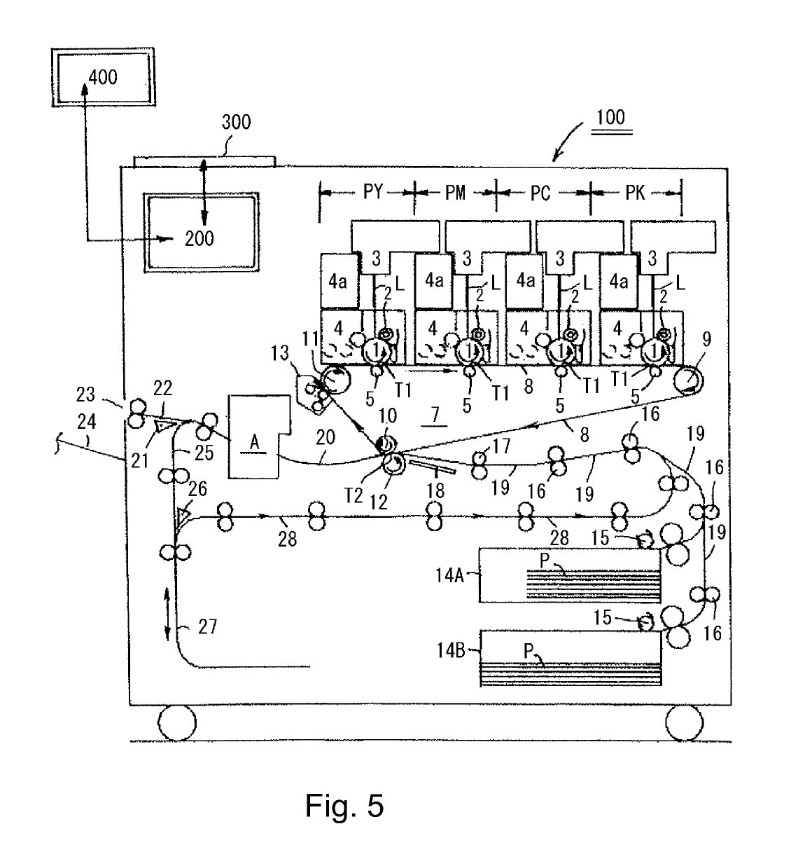

FIG. 5 is a schematic sectional view of an example of image forming apparatus 100, the fixing device A of which is an image heating apparatus in accordance with the present invention. This apparatus 100 is an electrophotographic image forming apparatus of the so-called tandem type, and also, of the intermediary transfer type. More specifically, it is a full-color laser print based on four primary colors, and has multiple (four) image formation stations which are sequentially disposed in parallel. It is capable of forming a color image on a sheet P of recording medium, based on the electrical information (electrical signals) of the image to be formed, which is inputted into the central control 200 of the apparatus 100 from a host apparatus 400. The apparatus 400 is a personal computer (PC), an external scanner (image reader), a network terminal, a facsimile (from which electrical signals are sent), a word processor, or the like. It is in connection to the central control 200 through an interface.

The sheet P of recording medium is a medium on which an image can be formed of toner. It is a sheet of paper, an OHT sheet, a label, a piece of fabric, etc. The central control 200 has a CPU (computation station). It exchanges various electrical information with the control panel 300 of the apparatus 100, and the host apparatus 400. It watches and controls the operation of each of the various devices within the apparatus 100, whereby it integrally controls the printing (image forming) operation of the apparatus 100, following preset control programs, and with reference to referential tables.

The apparatus 100 has four image formation stations, more specifically, the first to fourth image formation stations PY, PM, PC, and PK, which are disposed in tandem and in parallel from the left-to-right direction. The four image formation stations are the same in structure, although they are different in the color of the developer (which hereafter is referred to as toner) in a developing device 4 which each station has. Each image formation station is an electrophotographic image forming system which is independent in operation from the other.

Each image formation station has an electrophotographic photosensitive member 1, on which an electrostatic latent image is formed. The electrophotographic photosensitive member 1 is in the form of a rotatable drum (which therefore will be referred to simply as drum hereafter). Each drum 1 is rotated in the counterclockwise direction indicated by an arrow mark in the drawing at a preset speed. Further, each image formation station has a drum charging device 2, a drum exposing device 3, a developing device 4, a primary transfer charging device 5, and a drum cleaner 6.

The charging device 2 is a charging means for uniformly charging the peripheral surface of the drum 1 to preset polarity and potential level. In this embodiment, the drum exposing apparatus 3 is a laser scanner unit. The laser scanner 3 has: a semiconductor laser as a light source; a polygon mirror; an f-θ lens; etc. It scans (exposes) the uniformly charged portion of the peripheral surface of the drum 1 in each image formation station, with a beam L of laser light while modulating the beam L according to the information of the monochromatic image of one of the primary colors, into which the image to be formed was separated.

More concretely, the beam L of laser light outputted from the semiconductor is deflected by the polygon mirror which is being rotated. Thus, the beam of laser light is moved in an oscillatory manner while being deflected toward the peripheral surface of the drum 1, and is focused by the f-θ lens on the generatrix of the drum 1. Consequently, an electrostatic latent image which reflects the information of the image to be formed is formed on each drum 1.

The developing device 4 is a developing means for developing an electrostatic latent image on the peripheral surface of each drum 1, into a visible image formed of toner (toner image). It is supplied with toner by a toner supplying device 4a so that there is a preset amount of toner in the developing device 4. There are yellow, magenta, cyan, and black toners in the developers 4 of the image formation stations PY, PM, PC, and PK, respectively. The cleaner 6 is a cleaning means for removing the toner remaining on the peripheral surface of the drum 1 after the primary transfer.

The apparatus 100 has also an intermediary transfer belt unit 7, which extends under the image formation stations PY, PM, PC, and PK. The unit 7 has a flexible endless belt 8 as an image transferring intermediary member. The unit 7 has also a driver roller 9, a backup roller 10, and a tension roller 11. The backup roller 9 is the roller which backs up the endless belt 8 against the secondary transfer roller 12. The belt 8 is circularly driven by the roller 9 in the clockwise direction indicated by an arrow mark, at the same speed as the peripheral surface of the drum 1.

In this embodiment, the primary charging device 5 in each image formation station is a transfer roller (electrically conductive charge roller). It is on the inward side of the loop which the belt 8 forms. It is between the rollers 9 and 11 in terms of the moving direction of the belt 8, and is kept pressed against the downwardly facing portion of the peripheral surface of the drum 1, with the presence of the belt 8 between itself and drum 1. The area of contact (nip) between each drum 1 and belt 8 is the primary transfer station T1.

It is against the roller 10 that the second transfer roller 12 is pressed with the presence of the belt 8 between the two rollers 10 and 12. The roller 12 is an electrically conductive charge roller. The area of contact (nip) between the belt 8 and roller 12 is the second transfer station T2. Further, the image forming apparatus 100 is provided with a cleaner 13, which is in the area in which the belt 8 wraps around the roller 11. In this embodiment, the cleaner 13 employs a cleaning web (piece of unwoven cloth) as a cleaning means, which is placed in contact with the outward surface of the belt 8 to wipe away contaminants, such as the second transfer residual toner and paper dust, on the outward surface of the belt 8.

The image forming apparatus 100 has two (first and second) sheet feeder cassettes 14A and 14B in which multiple sheets P of recording medium are vertically stacked. The two sheet feeder cassettes 14A and 14b are vertically stacked below the unit 7. Further, the apparatus 100 has a sheet feeder roller 15, a pair of sheet conveyance rollers 16, a pair of registration rollers 17, a recording medium conveyance path 19 (which includes transfer station entrance guide 18), which are between the first sheet feeder cassette 14A (and second sheet feeder cassette 14B) and the second transfer station T2. Further, the apparatus 100 has a fixing device A, as a fixing means, which is on the downstream side of the second transfer station T2 in terms of the recording medium conveyance direction. The fixing device A will be described later.

The image forming operation carried out by the image forming apparatus 100 to form a full-color image is as follows: The drum 1 in each of the image formation stations PY, PM, PC, and PK is rotated in the counterclockwise direction indicated by the arrow mark at a preset peripheral velocity. Further, the belt 8 is circularly moved in the clockwise direction indicated by the arrow mark (so that its moving direction in first transfer nip becomes the same as that of peripheral surface of drum 1), at a speed which matches that of the peripheral surface of the drum 1. Further, the unit 3 (laser scanner) also is driven.

In synchronism with the driving of the abovementioned components, the peripheral surface of the drum 1 in each image formation station P is uniformly charged to preset polarity and potential level by the charging device 2 with preset control timing. Then, the unit 3 scans (exposes) the uniformly charged portion of the peripheral surface of each drum 1 with a beam L of laser light it projects while modulating the beam L according to the information of one of the four monochromatic images of the primary colors, into which the image to be formed was separated. Consequently, an electrostatic latent image of one of the primary colors is effected on the peripheral surface of each drum 1, with the preset control timing. Then, each electrostatic latent image is developed into a visible image (image formed of toner) by the corresponding developing device 4.

Through an electrostatic image formation process such as the one described above, a yellow (Y) toner image, which corresponds to the yellow component of the full-color image to be formed, is formed on the peripheral surface of the drum 1 in the image formation station PY. Then, the yellow toner image is transferred (primary transfer) onto the belt 8 in the transfer station T1.

On the drum 1 in the image formation station PM, a magenta toner image is formed, which corresponds to the magenta color component of the full-color image to be formed. Then, in the transfer station T1 of the second transfer station PM, the magenta toner image is transferred (primary transfer) onto the belt 8 in such a manner that it is layered on the yellow toner image, which has just been transferred onto the belt 8.

On the drum 1 in the image formation station PC, a cyan toner image is formed, which corresponds to the cyan color component of the full-color image to be formed. Then, in the transfer station T1 of the third transfer station PC, this magenta toner image is transferred (primary transfer) onto the belt 8 in such a manner that it is layered on the yellow and magenta toner images, which have just been transferred onto the belt 8.

On the drum 1 in the image formation station PK, a black toner image is formed, which corresponds to the black color component of the full-color image to be formed. Then, in the transfer stations T1 of the fourth transfer stations PK, this black toner image is transferred (primary transfer) onto the belt 8 in such a manner that it is layered on the yellow, magenta, and cyan toner images, which have just been transferred onto the belt 8.

To concretely describe the primary transfer of a toner image from the drum 1 onto the belt 8 in each image formation station P, a toner image is transferred by the electric field generated by a preset transfer bias applied to the roller 5 from an electric power source (unshown), and the pressure in the transfer nip. The transfer bias is opposite in polarity to the inherent polarity of the toner. It is at a preset level. As a result, an unfixed full-color toner image is synthetically effected on the belt 8 by the yellow (Y), magenta (M), cyan (C), and black (K) monochromatic toner images. The toner remaining on the peripheral surface of the drum 1 after the primary transfer of a toner image onto the belt 8 in each image formation station P is removed by the cleaner 6.

Meanwhile, the sheet feeder roller 15 is driven with a preset control timing, whereby one of the multiple sheet P of recording paper stacked in the cartridges 14A or 14B is fed, while being separated from the rest, into the main assembly of the image forming apparatus 100. Then, the sheet P is conveyed to the pair of registration rollers 17 through the recording medium conveyance path 19. The pair of registration rollers 17 are intermittently rotated or stopped with specific timing, by a motor (unshown), which is controlled by the central control 200. More concretely, as the sheet P is conveyed through the recording medium conveyance path 19, not only do the pair of registration rollers 17 straighten the sheet P in attitude by temporarily stopping the sheet P by the leading edge of the sheet P, but also, release the sheet P with preset control timing. After being released by the pair of registration rollers 17, the sheet P is guided into the second transfer station T2 by the transfer station entrance guide 18.

Then, the sheet P of recording paper is conveyed through the second transfer station T2 while remaining pinched between the secondary transfer roller 12 and belt 8. As the sheet P is conveyed through the second transfer station T2, the unfixed full-color toner image, that is, the layered four monochromatic toner images, different in color, on the belt 8 are transferred together (secondary transfer) onto the sheet P. To concretely describe the secondary transfer, a transfer bias, which is opposite in polarity to the normal polarity of the toner and is preset in potential level, is applied to the roller 12 from an electric power source (unshown). Thus, the unfixed full-color toner image on the belt 8 is transferred onto the sheet P by the electric field generated by the transfer bias, and the pressure in the transfer nip.

After the transfer of the unfixed full-color toner image onto the sheet P of recording paper, the portion of the surface of the belt 8, from which the unfixed full-color toner image is transferred, is moved to the cleaner 13 by the circular movement of the belt 8, and is moved along the cleaner 13. As it is moved along the cleaner 3, the contaminants such as the residual toner (second transfer residual toner) and paper dust, etc, on the belt 8 is removed by the cleaner 13, so that it can be repeatedly used for image formation. The cleaning member of the cleaner 13 in this embodiment is a piece of web (unwoven cloth), which is placed in contact with the surface of the belt 8 to wipe away the contaminants such as the residual toner, paper dust, and the like.

After being conveyed through the second transfer station T2, the sheet P of recording paper is separated from the surface of the belt 8 as if it is peeled away from the belt, and is introduced into the fixing device A through the recording medium conveyance path 20. Then, the sheet P is conveyed through the fixation nip of the fixing device A while being subjected to the heat and pressure in the fixation nip. As a result, the unfixed toner image on the sheet P becomes permanently fixed to the sheet P; it becomes a permanent image.

When the image forming apparatus 100 is in the one-sided printing mode, the sheet P of recording paper is introduced into a sheet discharge path 22 by the first flapper 21, which is in its first attitude, after being conveyed out of the fixing device A. Then, the sheet P is discharged into a delivery tray 24 through a sheet discharge opening 23, so that it is stacked in the delivery tray 24.

When the apparatus 100 is in the two-sided printing mode, after the sheet P of recording paper, on one or both surfaces of which an image has just been formed, is conveyed out of the fixing device A, the sheet P is guided into the sheet turning path 25 by the first flapper 21, which is kept in its second attitude. Then, it is introduced into a switch-back path 27 by the second flapper 26 which is kept in its first attitude. Then, it is introduced into a two-sided printing path 28 by the second flapper 26 which is kept in its second attitude.

Next, the sheet P is introduced from the two-sided printing path 28 into the recording medium conveyance path 19 for the second time. Then, it is introduced into the second transfer station T2 by way of the pair of registration rollers 17 and transfer station entrance guide 18, with its first surface, that is, the surface having a fixed toner image, facing away from the belt 8. Then, a toner image is transferred onto the second surface of the sheet P in the second transfer station T2.

Thereafter, the sheet P is conveyed through the recording medium conveyance path 20, fixing device A, and recording medium discharge path 22. Then, it is discharged into the delivery tray 24, being thereby stacked in the tray 22, as it is when the image forming apparatus 100 is in the one-sided printing mode. By the way, when the apparatus 100 is in the monochromatic mode, such as the black-and-white mode, a monochromatic image of the specified color is formed on one or both surfaces of the sheet P, and then, the sheet P having a monochromatic image on one or both of its surfaces is discharged into the delivery tray 24 to be stacked in the tray 24.

### <Fixing Device A>

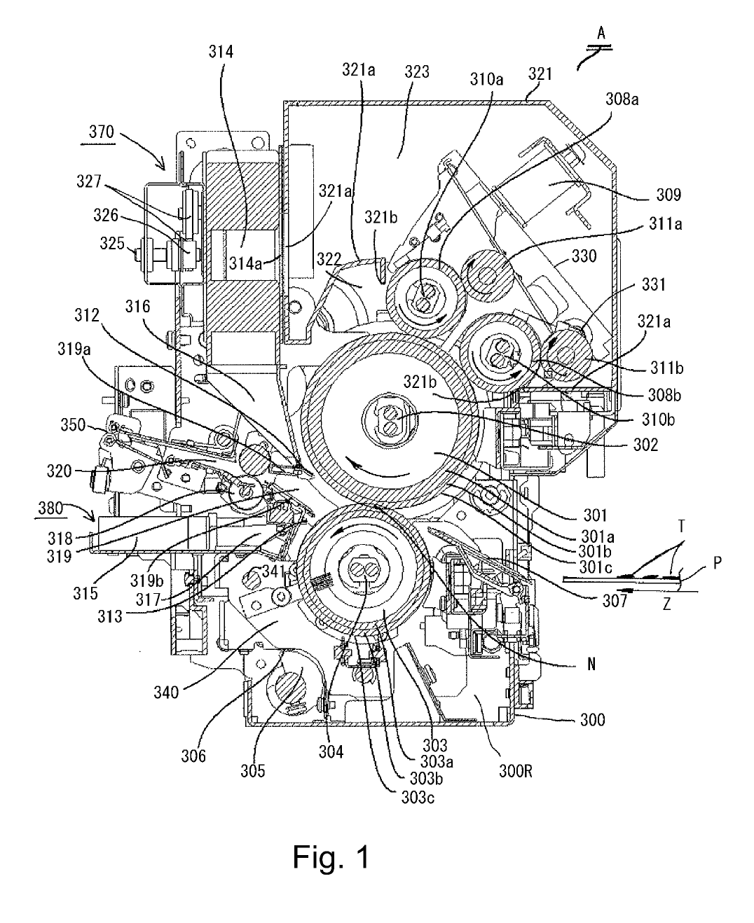

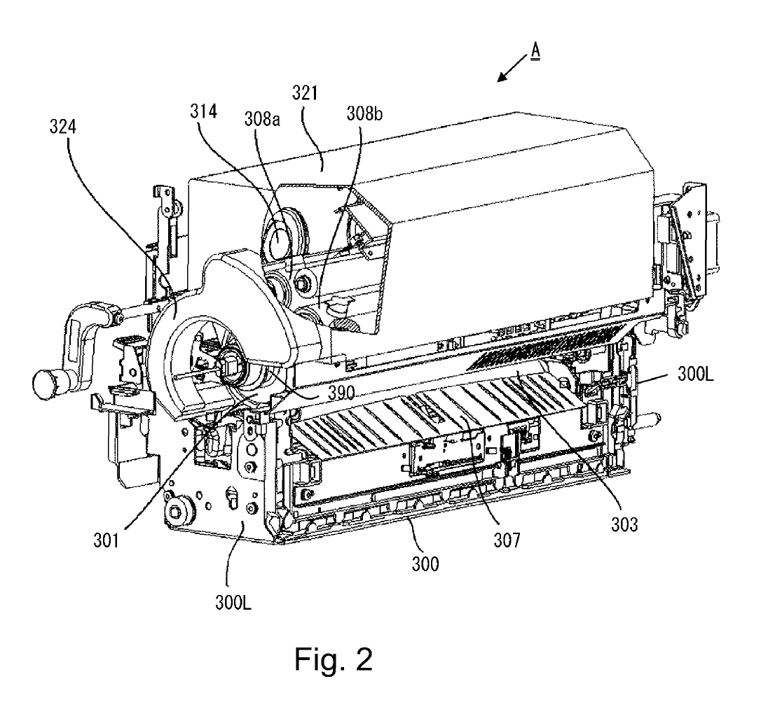

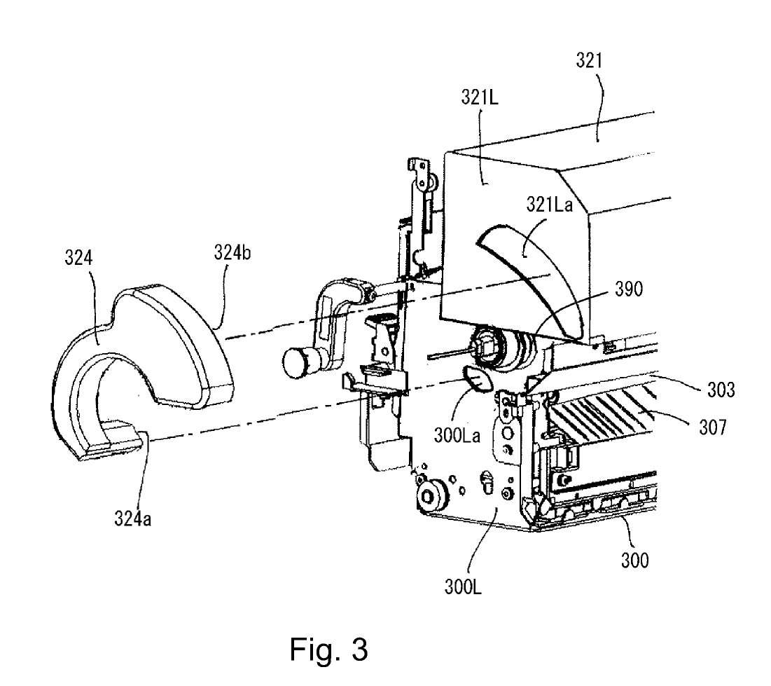

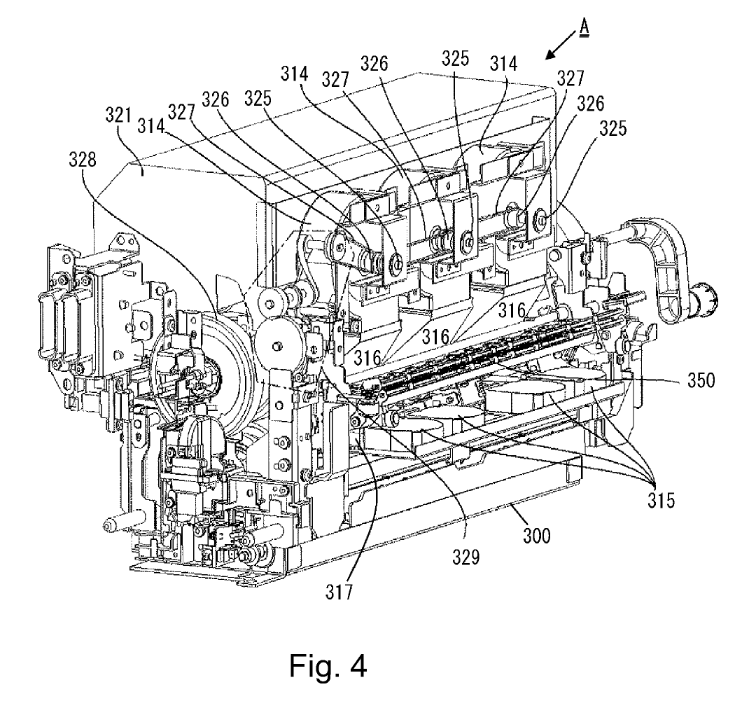

FIG. 1 is a vertical sectional view of the fixing device A in this embodiment, at a plane perpendicular to the axial line of the heat roller of the device A, as seen from the right-hand side of the device A. FIG. 2 is a partially broken perspective view of the fixing device A shown in FIG. 1, as seen from the recording medium entrance side (front side) of the device A. FIG. 3 is a partially exploded perspectively view of the left end portion of the fixing device A shown in FIG. 2. FIG. 4 is a partially broken perspective view of the fixing device A shown in FIG. 2, as seen from the recording medium exit side (rear side) of the device A.

The fixing device A in this embodiment is of the so-called heat roller type. It has: a heat roller 301 as a rotatable image heating member; and a pressure roller 303 as a rotatable pressure applying member which forms a fixation nip N, as a sheet pinching station, by being pressed upon the heat roller 301. Further, the fixing device A has also a fixing device entrance guide 307, which is on the upstream side of the nip N, in terms of the recording medium conveyance direction Z, to guide the sheet P into the nip N.

Further, the fixing device A has an air flow directing first device 370, which is on the downstream side of the nip N in terms of the recording medium conveyance direction Z. It is for facilitating the separation of the leading edge of the sheet P from the heat roller 301 by blowing air at the heat roller 301 from the downstream side of the nip N as the leading edge comes out of the nip N.

Further, the fixing device A has an air flow directing second device 380, which also is on the downstream side of the nip N, in terms of the recording medium conveyance direction N. It is for facilitating the separation of the leading edge of the sheet P from the pressure roller 303 by blowing air at the pressure roller 303 from the downstream side of the nip N as the sheet P comes out of the nip N.

### (1) Heat Roller 301

The heat roller 301 is a multilayer roller. It comprises a metallic core 301a, an elastic layer 301b, and a parting layer 301c. The metallic core 301a is hollow, and functions as the substrate of the roller 301. It is made of aluminum. The elastic layer 301b is formed of silicone rubber, and covers the entirety of the peripheral surface of the metallic core 301a. The parting layer 301c is made of a piece of PFA tube, and covers the entirety of the outward surface of the elastic layer 301b. The roller 301 is rotatably attached to the left and right lateral plates 300L and 300R of the fixing device frame 300 (chassis) by its left and right end portions, with the placement of a pair of bearings 390 between the left and right end portions of the roller 301 and the left and right lateral plates 300L and 300R, one for one.

There is a heater 302, as an internal heat source, in the hollow of the metallic core 301a. That is, the roller 302 is heated from within by the heater 302 so that its temperature remains at a proper level, for example, roughly 180° C.

Further, the fixing device A is provided with external heating members (auxiliary heating members) which are placed in contact with the peripheral surface of the roller 301 to externally heat the roller 301. They are in the adjacencies of the peripheral surface of the roller 301. More specifically, the fixing device A is provided with two external heat rollers 308a and 308b, which are disposed in parallel and in contact with the top side of the heat roller 301. Both external heat rollers 308a and 308b are rotatably supported by a frame 330.

The frame 330 is supported by a shaft 331 which is supported by the left and right lateral plates 300L and 300R of the fixing device frame 300, between the left and right lateral plates 300L and 300R, so that the frame 330 can be rotationally moved about the shaft 331. Further, the frame 330 is kept pressed toward the heat roller 301 by a compression spring 309 (elastic member) as a pressure applying means, being thereby allowed to rotationally move about the shaft 331. Thus, the rollers 308a and 308b are allowed to rotationally move about the shaft 331 while remaining in contact with the peripheral surface of the heat roller 301.

There are heaters 310a and 310b in the hollow of the rollers 308a and 308b, respectively, to heat the rollers 308a and 308b from within so that the temperature of the rollers 308a and 308b remains at their proper levels, for example, roughly 230° C., which is higher than the proper temperature level for the heat roller 301. That is, the rollers 308a and 308b play the role of externally supplying the heat roller 301 with heat, not only to reduce the length of time it takes to heat the heat roller 301 to its target temperature level after the fixing device A is activated, but also, to reduce the length of time it takes for roller 301 to recover in surface temperature after being reduced in surface temperature by image fixation.

The fixing device A is also provided with a pair of rotatable cleaning rollers 311a and 311b, which are rotatably supported by the frame 330, being kept pressed upon the peripheral surfaces of the corresponding rollers 308a and 308b to clean the peripheral surfaces of the rollers 308a and 308b, respectively.

### (2) Pressure Roller 303

The pressure roller 303 is under the heat roller 301. It is parallel to the heat roller 301. The roller 303 comprises a metallic core 303a, an elastic layer 303b, and a parting layer 303c. The metallic core 303a is hollow, and functions as the substrate of the roller 303. It is made of iron. The elastic layer 303b is formed of silicone rubber, and covers the entirety of the peripheral surface of the metallic core 303a. The parting layer 303c is made of a piece of PFA tube, and covers the entirety of the outward surface of the elastic layer 303b. The roller 303 is rotatably attached to the left and right lateral plates of the frame 340 by its left and right end portions, with the placement of a pair of bearings (unshown) between the left and right end portions of the roller 303 and the left and right lateral plates, one for one.

The frame 340 is supported by a shaft 341 which is supported between the left and right lateral plates 300L and 300R of the fixing device frame 300, by the left and right lateral plates 300L and 300R, so that the frame 340 can be rotationally moved about the shaft 341. The fixing device A is structured so that the frame 340 can be rotationally moved about the shaft 341 in the direction to press on the heat roller 301, or in the direction to separate from the heat roller 301. More specifically, the fixing device A is provided with a pressure application cam 305 and a cam seat 306. Thus, as the angle of the cam 305 relative to the cam seat 306 is controlled (changed) by the central control 200, the frame 340 is rotationally moved about the shaft 341 in the direction to cause the roller 303 to press on the roller 301 to generate a preset amount of contact pressure between the two rollers 303 and 301, or in the direction to cause the roller 303 to separate from the roller 301. As the frame 340 is rotationally moved into the position in which it causes the roller 303 to generate the preset amount of contact pressure, a nip (fixation nip N), which has a preset width in terms of the recording medium conveyance direction Z, is formed between the two rollers 303 and 301.

There is a heater 304 in the hollow of the roller 303 to heat the roller 303 from within to keep the temperature of the roller 303 at a proper level, for example, roughly 150° C.

### (3) Image Fixing Operation

The central control 200 starts an image formation control sequence in response to an image formation start signal, and controls the fixing device A so that the roller 303 is pressed upon the roller 301, and the roller 301 is rotated by the driving means (unshown) in the clockwise direction indicated by an arrow mark in FIG. 1 at a preset speed. The roller 308a and 308b, and roller 303, are rotated by the rotation of the roller 301. Further, the rollers 311a and 311b are rotated by the rotation of the rollers 308a and 308b, respectively.

Further, the central control 200 increases in temperature the rollers 301, 304, 308a, and 308b to their preset levels by supplying the heaters 302, 304, 310a, and 310b with electric power. Then, it controls the electric power supply for the heaters 302, 304, 310a, and 310b to keep the temperature of these rollers at their preset levels.

As soon as the image forming apparatus 100 is initialized as described above, the sheet P of recording paper, on which an unfixed image T is present, is conveyed to the fixing device A from the direction of the image formation stations. As the sheet P arrives at the fixing device A, it is guided into the nip N by the entrance guide 307, and then, is conveyed through the nip N while remaining pinched between the rollers 301 and 303, with its surface having the unfixed image facing the roller 301. As the sheet P is conveyed through the nip N, the unfixed image T on the sheet P is fixed to the surface of the sheet P by the heat and pressure applied to the sheet P and the image T thereon by the roller 301 and 303 in the nip N.

If the leading edge of the sheet P comes out of the nip N while remaining adhered to the roller 301, it is separated (peeled) from the roller 301 by the air flow directing first device 370, which will be described in detailed in Section (4). On the other hand, if the leading edge of the sheet P comes out of the nip N while remaining adhered to the roller 303, it is separated from the roller 303 by the air flow directing second device 380.

As the sheet P comes out of the nip N while being separated from the rollers 301 and 303, it is conveyed through the recording medium path 319 (top sheet path) formed by the top and bottom guides 319a and 319b, and then, is conveyed by a pair of recording medium conveyance rollers 318 from the path 319 to a recording medium conveyance path 320 (bottom sheet path). Then, the sheet P is moved out of the fixing device A through the sheet outlet 350.

### (4) Air Flow Directing Devices 370 and 380

The fixing device A is also provided with air flow directing first and second devices 370 and 380, respectively. The air flow directing first device 370 is for separating the sheet P of recording paper from the peripheral surface of the roller 301, and/or facilitating the separation of the sheet P from the peripheral surface of the roller 301, as the sheet P comes out of the nip N while remaining stuck to the peripheral surface of the roller 301. The air flow directing second device 380 is for separating the sheet P from the peripheral surface of the roller 303, and/or facilitating the separation of the sheet P from the peripheral surface of the roller 303, as the sheet P comes out of the nip N while remaining stuck to the peripheral surface of the roller 303.

(4-1) Air Flow Directing First device 370

The air flow directing first device 370 has an air exit 312 through which air is blown out toward the roller 301 from the downstream side of the nip N in terms of the recording medium conveyance direction Z to facilitate the separation of the leading edge of the sheet P of recording medium from the roller 301, and/or facilitating the separation of the sheet P from the roller 301, as the sheet P comes out of the nip N. Further, the air flow directing first device 370 has also multiple combinations of a fan 314 and a duct 316, which are for sending air to the air exit 312. The air outlet 312 is a slit, the lengthwise direction of which is parallel to the lengthwise direction of the roller 301 (direction of axial line of roller 301). In this embodiment, the air flow directing first device 370 has three combinations of a fan 314 and a duct 316, which are parallel to each other, and are in alignment in the lengthwise direction of the roller 301.

In this embodiment, the heated ambient air of the rollers 308a and 308b, which is higher in target temperature than the roller 301, is used as the separation air (air for separating the sheet P from roller 301). Therefore, the air flow directing first device 370 is provided with a hot air recovery duct 321, which is above the rollers 308a and 308b, and the edges of which are virtually in contact with the peripheral surface of the roller 308a and the peripheral surface of the roller 308b. With the hot air recovery duct 321 disposed as described above, the heated ambient air (hot or warm air) of the rollers 308a and 308b can be recovered and guided to the fans 314.

The inward surface of the duct 321 is covered with adiabatic resin or thermal insulator so that the heated air in the duct 321 can be guided to the fan 314 while being prevented from reducing in temperature. The opening of one end of the duct 321 is in connection to the intake opening 314a of the fan 314, and the opening of the other end of the duct 321 surrounds the rollers 308a and 380b.

As the fans 314 are driven, the heated air in the duct 321 is sent into the duct 316 through the openings 321a and 314a, and comes out of the opening 312. That is, the heated air in the duct 321 is blown at the roller 301 from the downstream side of the nip N in terms of the recording medium conveyance direction Z to facilitate the separation of the leading edge of the sheet P of recording paper from the roller 301, and facilitating the separation of the sheet P from the roller 301, as the sheet P comes out of the nip N.

The duct 321 has a partitioning plate 321a. That is, the duct 321 has a partitioning plate 321a which partitions the space 322 (first chamber), which contains the roller 301, from the space 323 (second chamber) which contains the roller 308a and 308b. The first chamber 322 is the chamber for the body of air having been heated to roughly 160° C. by coming into contact with the peripheral surface of the roller 301. The second chamber 323 is the chamber for the body of air having been heated to roughly 200° C. by coming into contact with the rollers 308a and 308b.

For the prevention of the intrusion of the ambient air from the first chamber 322 or the other areas outside the duct 321, into the duct 321, it is desired that the fixing device A is structured so that the edge of the partitioning plate 321a (=opening 321b of other end of duct 316) is positioned no more than 5 mm from the peripheral surface of the rollers 308a and 308b, or a flexible member (unshown) is placed in contact with the peripheral surface of the rollers 308a and 308b so that the second chamber 323 become virtually independent from the other spaces.

Since the fixing device A is structured as described above, the compressed air to be used for facilitating the separation of the sheet P of recording medium from the roller 301 can be made higher in temperature than the roller 301, without increase in the electric power consumption of the fixing device A. Therefore, the surface temperature of the heat roller 301 can be easily kept at a preset level. Therefore, it is possible to facilitate the separation of the sheet P from the heat roller 301 without causing the under-fixation attributable to the reduction in the temperature of the roller 301, while reliably continuing the fixing operation, without scarring the roller 301 and/or damaging the sheet P. Further, the above described structural arrangement for the fixing device A increases the fixing device A in the efficiency with which the air is jetted, and therefore, it improves the device A in its ability to separate the sheet P from the roller 301. Further, it does not require a heating means dedicated to the heating of the sheet separation air. Therefore, the fixing device A in this embodiment is significantly smaller than a conventional fixing device which is similar in the sheet separation performance to the fixing device A.

Further, the fixing device A in this embodiment is provided with a hot air (heated air) recirculation duct 324, which is for returning a body of heated air blown at the roller 301, by the air flow directing first device 370, to the duct 321 to recirculate the body of air, instead of simply exhausting it out of the device A. In other words, the temperature reduction of the surface layer of the heat roller 301, which is attributable to the blowing of the sheet separation air at the roller 301, is more effectively prevented by the recirculation of the heated air.

That is, referring to FIGS. 2 and 3, in this embodiment, the duct 324 is at the lengthwise left end of the fixing device A. Further, the left plate 300L of the fixing device frame 300 is provided with a heated air exit 300La, which corresponds in position to the recording medium conveyance path 319. Further, the left plate 321L of the duct 321 is provided with a heated air entrance 321La, which corresponds in position to the roller 308a and 308b.

The duct 324 is in connection to the abovementioned exit 300La and entrance 321La. It has the first and second openings 324a and 324b, which face the aforementioned exit 300La and entrance 321La (FIG. 3), respectively.

After a body of heated air is blown upon the heat roller 301 by the air flow directing first device 370, it flows toward the exit 300La through the recording medium conveyance path 319 because of the presence of the negative pressure generated by the driving of the fan 314. Then, the body of heated air enters the hot air recirculation duct 324 through the first opening 324a, and is returned to the hot air recovery duct 321 through the second opening 324b and entrance 321La, to be recirculated.

That is, the above described structural arrangement of the fixing device A makes it possible to recirculate heated air to reuse it to heat the roller 301, preventing thereby the main assembly of the image forming apparatus 100 from being increased in temperature by the exhaustion of the hot air from the fixing device A. Thus, it makes it unnecessary to provide an image forming apparatus with a ventilating device dedicated to the exhausting of the hot air attributable to the fixing device A, from the main assembly of the apparatus. Therefore, the image forming apparatus 100 does not have the ventilating device dedicated to the exhausting of the hot air attributable to the fixing device A, being therefore significantly lower in electrical power consumption than an image forming apparatus which employs a conventional fixing device having an air flow directing means.

Since the fixing device A is structured as described above, the body of heated air in the first chamber 322 (hot air chamber), which is roughly 160° C. in temperature, is made to stay on the surface layer of the roller 301. Therefore, fresh air is prevented from entering the first chamber 322. Therefore, the fixing device A does not suffer from the problem that the surface layer of the roller 301 is reduced in temperature by the fresh air that enters the fist chamber 322. Further, the heated air which is roughly 200° C. in temperature is recirculated to prevent the problem that the surface layer of the roller 301 is reduced in temperature by the blowing of air at the roller 301 to facilitate the separation the sheet P of recording medium from the heat roller 301.

Also in this embodiment, the air flow directing first device 370 has three fans 314, which are aligned in tandem in the lengthwise direction (direction of axial line) of the roller 301, in parallel to each other. Further, the air flow direction first device 370 is structured so that the three fans 314 are driven by the force transmitted from the roller 301 to the fans 314 through the driving force transmitting means.

That is, referring to FIG. 4, three shafts 325 which support the three fans 314, one for one, protrude rearward of the fans 314, and the protruding end of each shaft 325 is fitted with a pulley 326, around which the belt 327 for transmitting the shaft rotating force to the shaft 325 is wrapped. Further, the force for circularly driving the belt 327 is transmitted from a heat roller driving gear 328 for rotating the heat roller 301, to the belt 327 through a drive train 329 (driving force transmitting means). Thus, the force for rotating the roller 301 is partially transmitted to each of the three fans 314 by the driving force transmitting means 329, and drives the fans 314.

Therefore, the fixing device A does not have a driving force source dedicated to the driving of the fans 314, being therefore significantly lower in electrical power consumption than a conventional fixing device having an air flow directing device. Thus, the employment of the fixing device A in this embodiment by an image forming apparatus can significantly reduce the apparatus in electric power consumption.

### (4-2) Air Flow Directing Second Device 380

The air flow directing second device 380 has an air exit 313 through which air is blown at the roller 303 from the downstream side of the nip N in terms of the recording medium conveyance direction Z to facilitate the separation of the leading edge of the sheet P of recording medium as the sheet P comes out of the nip N. Further, the fixing device A is provided with multiple combinations of a fan 315 and a duct 317, which are for sending air to the exit (opening) 313. More concretely, the air exit 313 is a slit which is parallel to the lengthwise direction of the roller 303. Further, the air flow directing second device 380 in this embodiment is provided with four combinations of a fan 315 and a duct 317, which are aligned in tandem and in parallel in the direction parallel to the lengthwise direction of the roller 303.

In the case of this embodiment, each fan 315 is driven by a motor (unshown). However, the fixing device A may be structured so that the force for driving the roller 301 or 303 is utilized to drive each fan 315 as it is utilized to drive each fan 314 of the first air flow directing device. As each fan 315 is driven, the ambient air of the fixing device A is drawn into the duct 317, and then, is made to jet out of the exit 313.

Because the fixing device A is structured as described above, the body of air in the duct 317 is blown at the roller 303 from the downstream side of the nip N in terms of the recording medium conveyance direction Z, facilitating thereby the leading edge of the sheet P of recording medium to separate from the roller 303 as the sheet P comes out of the nip N. As the body of air comes out of the outlet 313, it strikes the downwardly facing surface of the sheet P as the sheet P is conveyed through the recording medium conveyance 319. Then, most of it escapes from the fixing device frame 300.

The air flow directing second device 380 also may be similarly structured to the air flow directing first device 370, so that the body of air heated by the heat from the rollers 308a and 308b and/or roller 301 or 303 is recirculated to be jetted out of the exit 313 of the air flow directing second device 380.

Incidentally, it is not mandatory that the fixing device A is provided with the air flow directing second device 380. That is, the provision of the air flow directing second device 380 is up to the designer of the fixing device A. Further, it is not mandatory that the rotatable heating member 301 is a roller. That is, the rotatable heating member 301 may be in the form of an endless belt. Further, the roller heating external members 308a and 308b may be such heating members that can heat the heating member 301 without being in contact with the heating member 301. Further, it is not mandatory that the pressure applying member is in the form of a rotatable member such as a roller. That is, the fixing device A may be structured so that a nonrotational (stationary) member such as a pressure application pad may be used as the pressure applying member.

Not only can an image heating apparatus in accordance with the present invention be used as a fixing device such as the fixing device A in the above described embodiment of the present invention, but also, an apparatus for applying heat and pressure to a fixed image on a sheet of recording medium to increase the fixed image in gloss, or the like apparatus.

As described above, according to the present invention, it is possible to provide an image heating apparatus which has an air flow directing device, and is significantly smaller in size and electric power consumption than a conventional image heating apparatus having an air flow directing device.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 193704/2010 filed Aug. 31, 2010 which is hereby incorporated by reference.

What is claimed is:

1. An image heating apparatus comprising:
a rotatable image heating member;
a pressing member for forming a nip for heating a the image formed on a recording material;
a external heating member for heating externally said image heating member;
a duct surrounding said external heating member; and
an air separating device for separating the recording material having passed through said nip from said heating member by blowing air supplied from said duct toward said image heating member from a downstream side of said nip with respect to a feeding direction of the recording material.

2. An apparatus according to claim 1, further comprising a second duct for returning the air blown by said air separating device to said first duct.

3. An apparatus according to claim 1, wherein said air separating device is driven by a driving force for said image heating member through drive transmitting means.

4. An apparatus according to claim 1, wherein said external heating member is press-contacted to said image heating member to heat image heating member and is controlled at a temperature higher than that of heating member.

5. An apparatus according to claim 1, wherein said duct is provided with a partition plate for partitioning into a space for said image heating member and a space for said external heating member.
